(19) United States
(12) Patent Application Publication
(10) Pub. No.: US 2007/0268066 A1
(43) Pub. Date: Nov. 22, 2007

(54) Method and device for stably controlling remote loading voltage

(75) Inventors: Wei-I Chen, Taipei (TW); Chin-Lung Lien, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/437,349

(22) Filed: May 19, 2006

(51) Int. Cl. G05F 1/10

(52) U.S. Cl. 327/538

(57) ABSTRACT

A method and device for stably controlling a loading voltage of a remote terminal device can be coupled to an electronic system such as a computer mainframe for stably controlling a remote loading voltage outputted by a power supply in the computer mainframe. When the power supply of the electronic system outputs a voltage to the remote terminal device, the loading voltage value actually received by the terminal device is continuously detected, and this detected loading voltage value is then compared with the predetermined rated loading voltage value; if the detected loading voltage is less than the rated loading voltage, then a loading current outputted to the terminal device is increased until the loading voltage at the terminal device is equal to the rated loading voltage. This allows a constant loading voltage to be received by the remote terminal device even over long conductive lines, so that the loading voltage will not be attenuated over distance.

### FIELD OF THE INVENTION

The present invention relates to an electrical circuit technique, and more particularly, to a method and device for stably controlling a loading voltage of a remote terminal device even over long distance.

### BACKGROUND OF THE INVENTION

In the application of electronic systems (e.g. Personal Computers), elongated cords are often needed to allow the electronic systems to supply power to a remote terminal device, such as a fan, a peripheral device etc. For example, a power supply is often employed in a Personal Computer (PC) research laboratory to allow a mainframe unit of a PC to send driving power to a peripheral device (e.g. a hard disk, a CD-ROM or a printer) a few meters away via a conductive wire.

However, based on basic circuitry principle, the resistance of a wire is proportional to its length; that is, the longer the wire, the larger the resistance. As shown in FIG. 1, assuming a power supply 10 is connected to a terminal device (i.e. load) via two conductive wires 30 and 31, then the resistance R of the two conductive wires are rated below:

R=ρ×(L/A)

wherein

ρ: resistivity of the material of the conductive wires 30 and 31

L: length of the conductive wires 30 and 31

A: cross-sectional area of the conductive wires 30 and 31

In the case shown in FIG. 1, as the length L of the conductive wires 30 and 31 increases, the voltage received by the remote terminal device 20 decreases accordingly. That is, if the input voltage of the power supply 10 is Vₒ, then the loading voltage V_{L} received by the remote terminal device 20 is smaller than Vₒ, that is, V_{L}<Vₒ; and that the longer the conductive wires 30 and 31, the smaller the loading voltage V_{L}.

One prior solution to the above problem is to adjust the length L of the conductive wires 30 and 31 to reduce its resistance. For example, if the power supply 10 and the terminal device 20 are coupled via a socket, the length of the conductive wires 30 and 31 is then reduced, and thus reducing the resistance R. Additionally, another conventional solution is increase the cross-sectional area A of the conductive wires 30 and 31 to accordingly reduce its resistance R. However, such an approach requires the addition of a socket or enlargement of the cross-sectional area A of the conductive wires 30 and 31, this increases the equipment cost and is not cost effective.

Moreover, when the loading voltage V_{L} of the remote terminal device 20 requires some adjustment (e.g. increase or decrease), the output voltage Vₒ, of the power supply 10 needs to be adjusted accordingly. Currently, the output voltage Vₒ of the power supply 10 is manually adjusted. However, in some special applications, up to about 70,000 changes per second for the loading voltage may be required. Under this circumstance, manual adjustment of the output voltage Vₒ of the power supply 10 is impossible to implement.

### SUMMARY OF THE INVENTION

In the light of forgoing drawbacks, an objective of the present invention is to provide a method and device for stably controlling a remote loading voltage applicable to a computer mainframe that allows a remote terminal device connected to the computer mainframe to receive a constant voltage even over lengthy of wires.

In accordance with the above and other objectives, the present invention provides a method and device for stably controlling a remote loading voltage applicable to power supply of an electronic system such as a computer mainframe. The power supply is connected to a terminal device via a pair of conductive lines. The method comprises the steps of: (1) detecting a loading voltage actually received by the terminal device when the power supply providing an output voltage to the terminal device; (2) comparing the detected loading voltage value with a rated loading voltage of the terminal device, outputting a zero differential signal if the two values are substantially equal and outputting a negative differential signal if the detected loading voltage value being smaller than the rated loading voltage of the terminal device; and (3) increasing a loading current of the terminal device in response to the negative differential signal until the detected loading voltage value equal to the rated loading voltage of the terminal device such that the comparison module outputs a zero differential signal.

The device for stably controlling a remote loading voltage comprises: (A) a loading voltage detecting module for detecting a loading voltage actually received by the terminal device when the power supply providing an output voltage to the terminal device; (B) a comparison module for comparing the detected loading voltage value with a rated loading voltage of the terminal device, outputting a zero differential signal if the two values are substantially equal and outputting a negative differential signal if the detected loading voltage value being smaller than the rated loading voltage of the terminal device; and (C) a current adjusting module for outputting a loading current to the terminal device in response to the output voltage provided by the power supply and increasing a loading current of the terminal device in response to the negative differential signal until the detected loading voltage value equal to the rated loading voltage of the terminal device such that the comparison module outputs a zero differential signal.

The present invention is characterized in that when the power supply of the electronic system outputs a voltage to the remote terminal device, the loading voltage value actually received by the terminal device is continuously detected, and this detected loading voltage value is compared with the predetermined rated loading voltage value; if the detected loading voltage is less than the rated loading voltage, then a loading current outputted to the terminal device is increased until the loading voltage at the terminal device is equal to the rated loading voltage. This allows a constant loading voltage to be received by the remote terminal device even over long conductive lines, so that the loading voltage will not be attenuated over distance.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a schematic circuit structure depicting a circuit structure of conventional connection between a computer mainframe and a peripheral device.

FIG. 2 is an application diagram depicting the application of the device for stably controlling a remote loading voltage of the present invention coupled between a computer mainframe and a peripheral device.

FIG. 3 is a schematic diagram showing the inner structure of the device for stably controlling a remote loading voltage of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

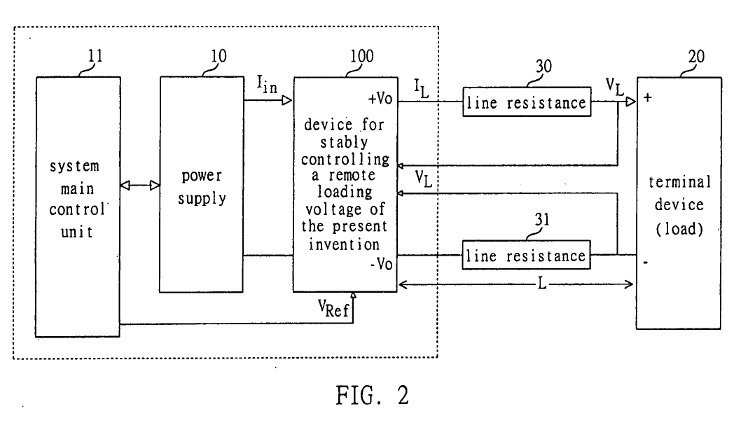

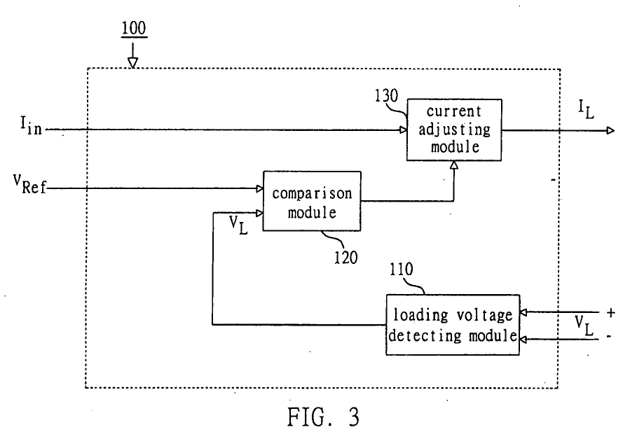

The method and device for stably controlling a remote loading voltage according to the present invention is described in details in conjunction with FIGS. 2 and 3.

FIG. 2 shows the application and infrastructure of the device for stably controlling a remote loading voltage of the present invention (indicated by block 100). As shown, the device for stably controlling a remote loading voltage 100 of the present invention is coupled to a power supply 10 (e.g. a power supply insider a PC), and the power supply 10 is controlled by a system main control unit 11 (i.e. a main control unit of a PC mainframe). The device 100 is connected to a terminal device (e.g. a hard disk, a CD-ROM, a printer etc.) via a pair of conductive lines 30 and 31. The power supply 10 provides a function of stably controlling the remote loading voltage to the terminal device 20, such that the terminal device 20 can receive a constant loading voltage even under the presence of long conductive lines 30 and 31 that would typically attenuate voltage. In other words, the loading voltage will not decrease over distance. In actual implementation, the power supply 10 provides, for example, a driving voltage of 19 V, which is sent to the terminal device via the conductive lines 30 and 31.

As shown in FIG. 2, the basic structure of the device for stably controlling a remote loading voltage 100 of the present invention includes: (a) a loading voltage detecting module 110; (b) a comparison module 120; and (c) a current adjusting module 130. In actual implementation, the device for stably controlling a remote loading voltage 100 of the present invention can be made as a single module in advance, and coupled to the power supply 10 by a user when needed. Alternatively, the device 100 of the present invention can be integrated into the motherboard of a PC by computer manufacturers.

The individual characteristics and functionality of each element 110, 120 and 130 of the device for stably controlling a remote loading voltage 100 of the present invention are explained below.

The loading voltage detecting module 110 is coupled to two terminals of the loading voltage of the terminal device 20 at a remote site. The loading voltage detecting module 110 is used to detect the loading voltage V_{L} actually received in response to the provision of an output voltage Vₒ from the power supply 10 to the terminal device 20 via the conductive lines 30 and 31. In actual implementation, the loading voltage detecting module 110 is a differential amplifier. Two terminals of the differential amplifier are respectively connected to the two terminals of the terminal device 20, so as to detect the potential difference between these two terminals of the terminal device 20 and thus determine the loading voltage V_{L}.

The comparison module 120 compares the loading voltage value V_{L} actually detected by the above loading voltage detecting module 110 with the rated loading voltage value V_{Ref} of the terminal device 20 (the actual value of V_{Ref} is controlled for example by the system main control unit 11, that is, the user may set V_{Ref} via software and the setting of V_{Ref} is then sent from the system main control unit 11 to the comparison module 120). If the actual loading voltage value V_{L} is approximately equal to the rated loading voltage value V_{Ref} of the terminal device 20 (i.e. V_{L}=V_{Ref}), then the comparison module 120 sends a zero differential signal; if the actual loading voltage value V_{L} is greater than the rated loading voltage value V_{Ref} of the terminal device 20 (i.e. V_{L}>V_{Ref}), then the comparison module 120 sends a positive differential signal; else if the actual loading voltage value V_{L} is less than the rated loading voltage value V_{Ref} of the terminal device 20 (i.e. V_{L}<V_{Ref}), then the comparison module 120 sends a negative differential signal. In actual implementation, the comparison module 120 is for example an analog or digital comparator that outputs a positive voltage as the positive differential signal when V_{L}>V_{Ref} and outputs a negative voltage as the negative differential signal when V_{L}<V_{Ref}.

The current adjusting module 130 outputs a loading current I_{L} to the terminal device 20 in response to the output voltage Vₒ, of the power supply 10. Furthermore, it may boost its loading current I_{L} when a negative differential signal is outputted by the above comparison module 120 until the loading voltage V_{L} of the terminal device equals to its rated loading voltage (i.e. V_{L}=V_{Ref}), such that the comparison module 120 sends out the zero differential signal.

The operations of the device for stably controlling a remote loading voltage 100 of the present invention in actual implementation are illustrated using an example.

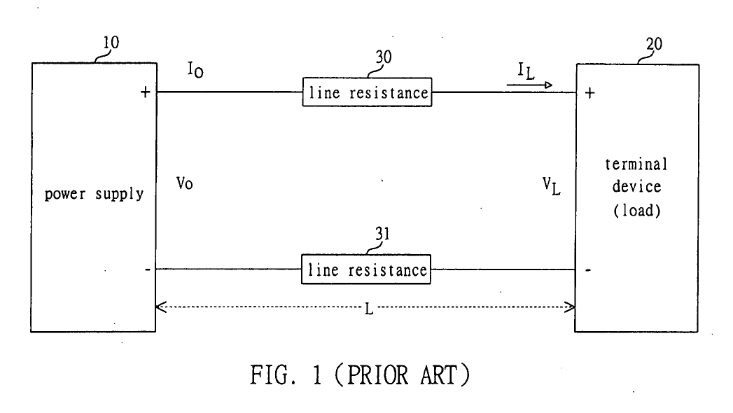

Referring to FIGS. 1 and 2, in actual implementation, when the power supply 10 is activated to supply the output voltage Vₒ to the terminal device 20 via the conductive lines 30 and 31, the loading voltage detecting module 110 of the device for stably controlling a remote loading voltage 100 of the present invention is activated in response to detect the loading voltage V_{L} actually received by the terminal device 20 and feed the detected loading voltage V_{L} to the comparison module 120, so that the comparison module 120 compares the loading voltage V_{L} with the rated loading voltage V_{Ref} of the terminal device 20. If V_{L}=V_{Ref}, then the comparison module 120 outputs a zero differential signal; if V_{L}>V_{Ref}, then the comparison module 120 outputs a positive differential signal; if V_{L}<V_{Ref}, then the comparison module 120 outputs a negative differential signal.

In the case of the comparison module 120 outputs a zero differential signal, the current adjusting module 130 will not adjust the loading current I_{L}. On the opposite, if the comparison module 120 outputs a negative differential signal, the current adjusting module 130 responsively increases the loading current I_{L} until the loading voltage V_{L} of the terminal device equals to its rated loading voltage (i.e. V_{L}=V_{Ref}), such that the comparison module 120 sends out the zero differential signal.

In summary, the present invention provides a method and device for stably controlling a remote loading voltage that can be coupled to an electronic system for stably controlling a remote loading voltage. When a power supply of the electronic system outputs a voltage to a remote terminal device, the loading voltage value actually received by the terminal device is continuously detected, and this detected loading voltage value is then compared with the predetermined rated loading voltage value; if the detected loading voltage is less than the rated loading voltage, then a loading current outputted to the terminal device is increased until the loading voltage at the terminal device is equal to the rated loading voltage. This allows a constant loading voltage to be received by the remote terminal device even over long conductive lines, so that the loading voltage will not be attenuated over distance. Thus, the present invention is useful and inventive over the prior art.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

### FIG. 1 (PRIOR ART)

10—power supply

30, 31—line resistance

20—terminal device (load)

### FIG. 2

10—power supply

11—system main control unit

20—terminal device (load)

30, 31—line resistance

100—device for stably controlling a remote loading voltage of the present invention

### FIG. 3

110—loading voltage detecting module

120—comparison module

130—current adjusting module

What is claimed is:

1. A method for stably controlling a remote loading voltage applicable to a power supply, the power supply connecting to a terminal device via a pair of conductive lines, the method comprising:
detecting a loading voltage actually received by the terminal device when the power supply providing an output voltage to the terminal device;
comparing the detected loading voltage value with a rated loading voltage of the terminal device, outputting a zero differential signal if the two values are substantially equal and outputting a negative differential signal if the detected loading voltage value being smaller than the rated loading voltage of the terminal device; and
increasing a loading current of the terminal device in response to the negative differential signal until the detected loading voltage value equal to the rated loading voltage of the terminal device such that the comparison module outputs a zero differential signal.

2. The method for stably controlling a remote loading voltage of claim 1, wherein the power supply is a power supply in a computer mainframe.

3. The method for stably controlling a remote loading voltage of claim 1, wherein the terminal device is a computer peripheral device.

4. A device for stably controlling a remote loading voltage applicable to a power supply, the power supply connecting to a terminal device via a pair of conductive lines, the device comprising:
a loading voltage detecting module for detecting a loading voltage actually received by the terminal device when the power supply providing an output voltage to the terminal device;
a comparison module for comparing the detected loading voltage value with a rated loading voltage of the terminal device, outputting a zero differential signal if the two values are substantially equal and outputting a negative differential signal if the detected loading voltage value being smaller than the rated loading voltage of the terminal device; and
a current adjusting module for outputting a loading current to the terminal device in response to the output voltage provided by the power supply and increasing a loading current of the terminal device in response to the negative differential signal until the detected loading voltage value equal to the rated loading voltage of the terminal device such that the comparison module outputs a zero differential signal.

5. The device for stably controlling a remote loading voltage of claim 4, wherein the power supply is a power supply in a computer mainframe.

6. The device for stably controlling a remote loading voltage of claim 4, wherein the terminal device is a computer peripheral device.

7. The device for stably controlling a remote loading voltage of claim 4, wherein the loading voltage detecting module is a differential amplifier.

8. The device for stably controlling a remote loading voltage of claim 4, wherein the comparison module is a digital comparator.
